(19) United States
(12) Patent Application Publication
(10) Pub. No.: US 2006/0156511 A1
(43) Pub. Date: Jul. 20, 2006

(54) Caster

(76) Inventor: Yuan Jeng Li, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/037,364

(22) Filed: Jan. 19, 2005

(51) Int. Cl. B60B 33/00

(52) U.S. Cl. 16/20

(57) ABSTRACT

A caster including a seat body and a wheel pivotally connected between two support arms of the seat body. An upper cover is disposed on the seat body. A support rod extends through the seat body and the upper cover to pivotally connect with a bearing. A first groove is formed on top face of the seat body and the upper cover is formed with a second groove corresponding to the first groove, whereby the first groove and the second groove together form an annular space. Multiple ball bodies are arranged in the annular space.

### BACKGROUND OF THE INVENTION

The present invention is related to a caster which is able to durably bear the axial force and radial force coming from the support rod.

FIG. 4 shows a conventional caster including a seat body 7 on which a wheel 71 is pivotally connected. A ball bearing 72 is disposed in the seat body 7. The ball bearing 72 has an outer ring 721 and an inner ring 722. The outer ring 721 is fixed on the seat body 7, while the inner ring 722 is fixedly connected with a support bar 73, whereby the caster can be pivoted about the support bar 73.

When an external force is applied to the inner ring 722, a shear force is produced between the inner ring 722 and the outer ring 721. Therefore, the ball bearing 72 will be worn out after a long period of use. The conventional caster has poor axial load capacity so that such caster can hardly bear greater load. Also, such caster cannot be durably used.

FIG. 5 shows an improved caster including a seat body 8 on which a wheel 81 is pivotally connected. The seat body 8 has a base seat 82 and a cover body 83 connected with each other via a ball bearing 84. The base seat 82 is equipped with a taper roller bearing 85 having an inner ring 851 and an outer ring 852 obliquely connected with each other. The outer ring 852 is fixedly connected with the base seat 82. A support bar 86 axially extends through the seat body 8. The inner ring 851 is connected with one end of the support bar 86.

In the improved caster, the axial load capacity and lateral component force of the support bar 86 are improved by means of the taper roller bearing 85 and the ball bearing 84. However, the taper roller bearing 85 is manufactured at high cost. Therefore, it is not economic to use such caster.

### SUMMARY OF THE INVENTION

It is therefore a primary object of the present invention to provide a caster which includes two bearings for durably bearing the axial force and radial force coming from the support rod.

According to the above object, the caster of the present invention includes:
a seat body having a connecting section, two opposite sides of the connecting section being, downward bent to form two support arms, the seat body further having a fixing seat downward extending from a center of the connecting section, an annular first groove being formed on top face of the connecting section around the fixing seat;
a wheel pivotally connected between the two support arms of the seat body;
an upper cover disposed on the connecting section of the seat body, the upper cover being formed with a second groove corresponding to the first groove, whereby the first groove and the second groove together form an annular space, multiple ball bodies being arranged in the annular space;
a bearing disposed in the fixing seat of the seat body, the bearing having an inner ring and an outer ring, the inner ring having a shaft hole; and
a support rod, one end of the support rod being fixed in the shaft hole of the inner ring of the bearing, the other end of the support rod extending out of the connecting section of the seat body and the upper cover, whereby the ball bodies are able to bear the axial thrusting force of the support rod, while the bearing is able to bear the radial thrusting force of the support rod.

The present invention can be best understood through the following description and accompanying drawings wherein:

### BRIEF DESCRIPTION OF THE DRAWINGS

FIG. 1 is a perspective view of the present invention;

FIG. 2 is a sectional view of a first embodiment of the present invention;

FIG. 3 is a sectional view of a second embodiment of the present invention;

FIG. 4 is a sectional view of a conventional caster; and

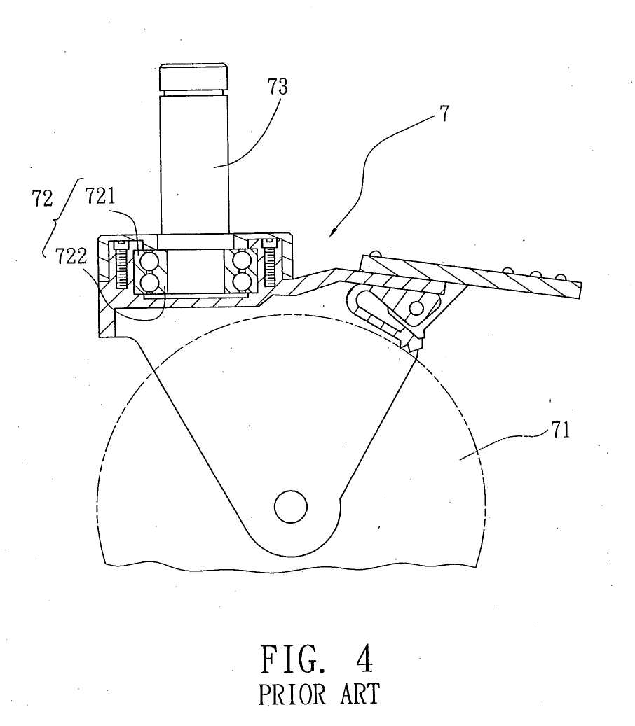

FIG. 5 is a sectional view of an improved conventional caster.

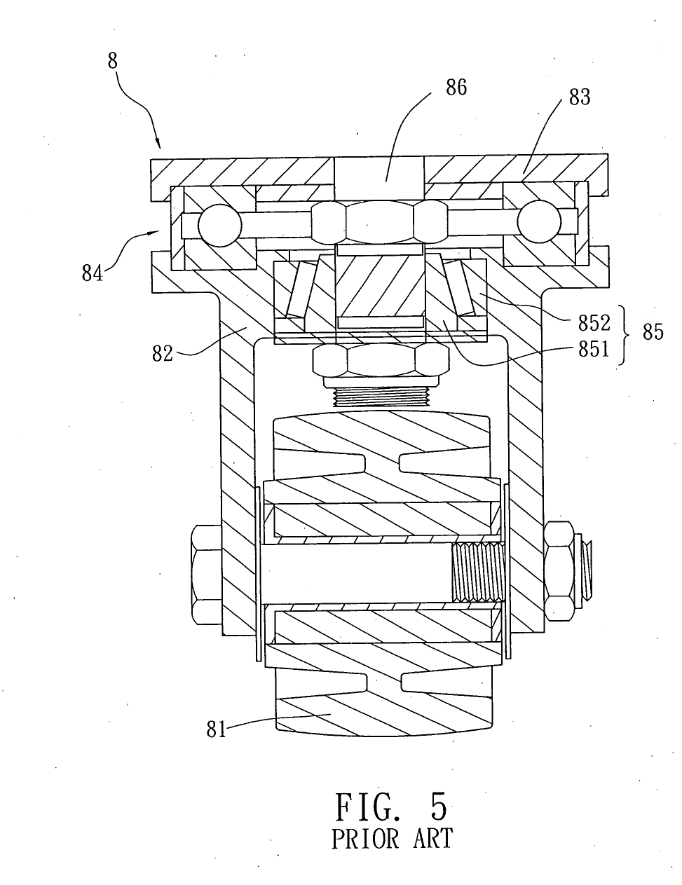

### DETAILED DESCRIPTION OF THE PREFERRED EMBODIMENTS

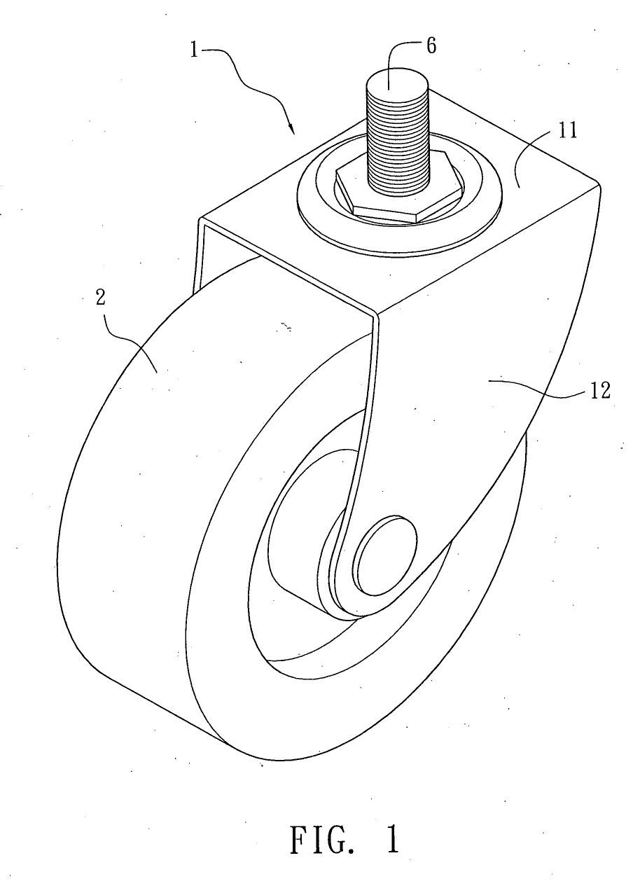

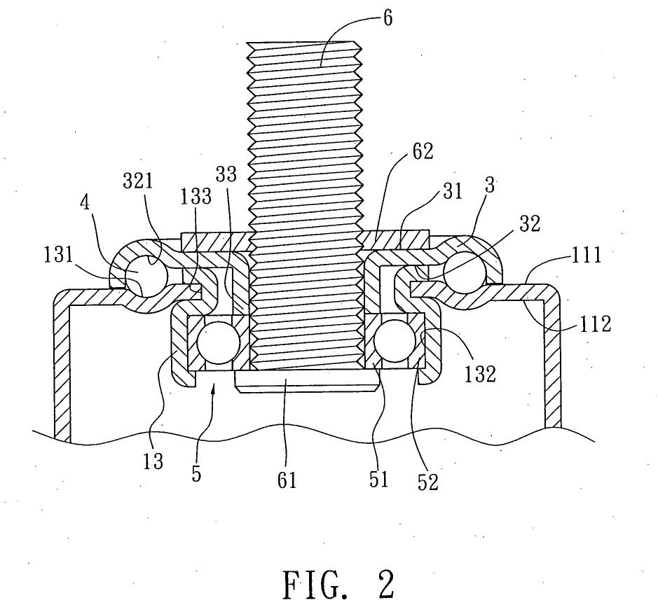

Please refer to FIGS. 1 and 2. The caster of the present invention includes a seat body 1 having a connecting section 11. Two opposite sides of the connecting section 11 are downward bent to form two support arms 12. The seat body 1 further has a fixing seat 13 downward extending from the center of the connecting section 11. The connecting section 11 has a first top face 111 and a first bottom face 112. The first top face 111 of the connecting section 11 is formed with an annular first groove 131 around the fixing seat 13. In addition, the fixing seat 13 has a fixing space 132 vertically passing through the fixing seat 13. Also, the fixing seat 13 has a channel 133.

The present invention further includes a wheel 2 pivotally connected between the two support arms 12 of the seat body.

The present invention further includes an upper cover 3 disposed on the connecting section 11. The upper cover 3 has a second top face 31 and a second bottom face 32. An abutting section 33 downward extends from inner circumference of the upper cover 3. The second bottom face is formed with a second groove 321 corresponding to the first groove 131. The first groove 131 and the second groove 321 together form an annular space (not shown).

The present invention further includes multiple ball bodies 4 arranged in the annular space.

The present invention further includes a bearing 5 disposed in the fixing seat 13. The bearing 5 has an inner ring 51 and an outer ring 52. The inner ring 51 has a shaft hole (not shown). The abutting section 33 of the upper cover 3 abuts against the inner ring. An inner rim of the seat body is inserted in the channel 133 of the fixing seat 13. The fixing seat 13 downward extends to enclose the outer ring of the bearing 5.

The present invention further includes a support rod 6 having a head section 61 at one end. The diameter of the head section 61 is larger than the diameter of the shaft hole of the inner ring 51. The support rod 6 is fixed in the shaft hole of the inner ring 51. The other end of the support rod 6 extends out of the connecting section 11 and the upper cover 3 and is locked with a nut 62.

The ball bodies 4 are able to bear the axial thrusting force of the support rod 6, while the bearing 5 is able to bear the radial thrusting force of the support rod 6.

When an external force is applied to the support rod 6, the axial force is transmitted from the upper cover 5 through the ball bodies 6 to the connecting section 11. Therefore, the area for bearing the axial load is larger so that the present invention is able to bear greater force. Also, when the seat body 1 is radially pushed by the support rod 6 to move, the radial force coming from the support rod 6 is transmitted through the inner ring 51 to the outer ring 52 and then to the connecting section 11. The contact area is also larger so that the bearing 5 can the radial force of the support rod 6. The present invention is manufactured at lower cost. In addition, the structure of the present invention can bear the axial force and radial force. Even after a long period of use, the support rod 4 can be still tightly fitted in the seat body 1 and the caster can be smoothly operated.

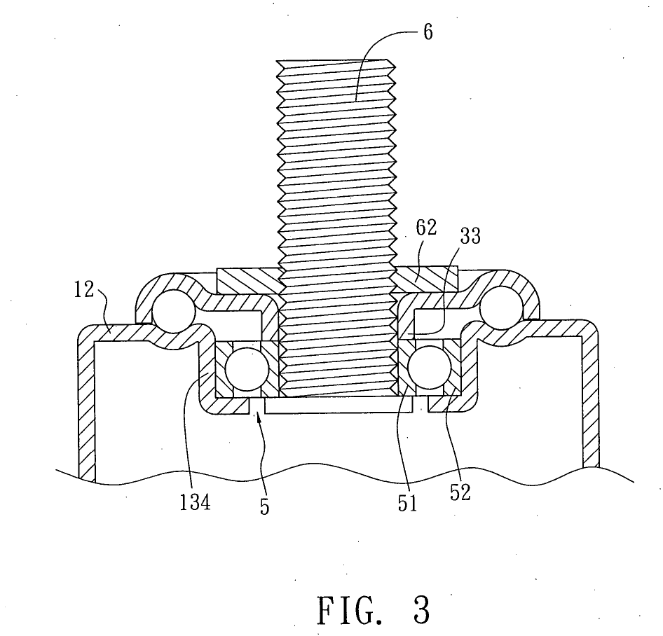

FIG. 3 shows a second embodiment of the present invention, wherein the fixing seat 13 is integrally connected with the seat body 1 to enclose the outer ring 52. The fixing seat 13 is formed with a recessed section 134 in which the outer ring 32 is tightly fitted.

The above embodiments are only used to illustrate the present invention, not intended to limit the scope thereof. Many modifications of the above embodiments can be made without departing from the spirit of the present invention.

What is claimed is:

1. A caster comprising:
a seat body having a connecting section, two opposite sides of the connecting section being downward bent to form two support arms, the seat body further having a fixing seat downward extending from a center of the connecting section, the connecting section having a fixing space vertically passing through the fixing seat;
a wheel pivotally connected between the two support arms of the seat body;
an upper cover disposed on the connecting section of the seat body;
a bearing disposed in the fixing seat of the seat body, the bearing having an inner ring and an outer ring, the inner ring having a shaft hole, the outer ring enclosing the inner ring; and
a support rod, one end of the support rod being fixed in the shaft hole of the inner ring of the bearing, the other end of the support rod extending out of the connecting section of the seat body and the upper cover.

2. The caster as claimed in claim 1, wherein an annular first groove is formed on top face of the connecting section around the fixing seat.

3. The caster as claimed in claim 2, wherein the upper cover is formed with a second groove corresponding to the first groove, whereby the first groove and the second groove together form an annular space.

4. The caster as claimed in claim 3, wherein multiple ball bodies are arranged in the annular space.

5. The caster as claimed in claim 1, wherein the upper cover is ring-shaped and an abutting section downward extends from inner circumference of the upper cover for abutting against the inner ring of the bearing.

6. The caster as claimed in claim 1, wherein the fixing seat is integrally connected with the seat body to enclose the outer ring of the bearing.

7. The caster as claimed in claim 1, wherein an inner rim of the seat body is inserted in a channel of the fixing seat, the fixing seat downward extending to enclose the outer ring of the bearing.
